(19) United States
(12) Patent Application Publication
(10) Pub. No.: US 2026/0044511 A1
(43) Pub. Date: Feb. 12, 2026

(54) AI-BASED STRUCTURED META PROMPT GENERATION WITH OPTIONAL USER INPUTS

(71) Applicant: Microsoft Technology Licensing, LLC, Redmond, WA (US)

(72) Inventors: Caitlyn Elizabeth ZAWIDEH, Seattle, WA (US); Mengke LI, Bellevue, WA (US); John Matthew MANGINO, Ellicott City, MD (US)

(73) Assignee: Microsoft Technology Licensing, LLC, Redmond, WA (US)

(21) Appl. No.: 18/797,941

(22) Filed: Aug. 8, 2024

(51) Int. Cl. G06F 16/2455; G06N 3/0475

(52) U.S. Cl. CPC G06F 16/24553; G06N 3/0475

(57) ABSTRACT

A data processing system implements receiving, via a user interface, report context and a request to generate insights of a data report; constructing a first prompt by appending the request a default system prompt, the report context, and the data report as a first instruction string; validating the first prompt using a second generative model by checking whether the first prompt is structured according to sections that contain one or more predetermined purposes and whether the default system prompt is responsive to the report context; when the first prompt is validated by the second generative model, providing the first prompt to the first generative model; generating, by the first generative model and according to the first prompt, an insight output; receiving the insight output from the first generative model; and providing the insight output to display on the user interface.

### BACKGROUND

Service platform administrators are responsible for the smooth operation and performance of a service platform. The data reports they review vary depending on the specific services, such as data reports on user activities, platform performances, security, business metrics, and the like. It has become increasingly desirable to automatically summarize the data reports as insights, and to recommend actions for the administrators to take in response to the insights. Artificial Intelligence (AI) has the potential to automate our lives to save time and increase productivity, while prompt engineering is crucial to get desired outputs from generative AI models. However, it is time-consuming for prompt engineers to manually craft meta prompts for generating insights of different kinds of data reports with respect to various platform services. In addition, not all administrators are skilled in prompt engineering. Hence, there is a need for systems and methods for automating meta prompt generation thereby generating data report insights with efficiency, maintainability, and security.

### SUMMARY

An example data processing system according to the disclosure includes a processor and a machine-readable medium storing executable instructions. The instructions when executed cause the processor alone or in combination with other processors to perform operations including receiving, via a user interface of a client device, a request to generate insights of a data report associated with a service platform; providing a query for report context to display on the user interface of the client device; receiving, via the user interface of the client device, the report context; constructing, via a prompt construction unit, a first prompt by appending the request, a default system prompt, the report context, and the data report as a first instruction string, the first instruction string including instructions to a first generative model, and the default system prompt being structured in sections each of which is defined with one or more predetermined purposes addressing different aspects of the instructions for the first generative model to follow when generating the insights; validating the first prompt using a second generative model by checking whether the first prompt is structured according to the sections that contain one or more predetermined purposes and whether the default system prompt is responsive to the report context; when the first prompt is validated by the second generative model, providing as an input the first prompt to the first generative model; generating, by the first generative model and according to the first prompt, an insight output; receiving as an output the insight output from the first generative model; and providing the insight output to display on the user interface of the client device.

An example method implemented in a data processing system includes receiving, via a user interface of a client device, a request to generate insights of a data report associated with a service platform; providing a query for report context to display on the user interface of the client device; receiving, via the user interface of the client device, the report context; constructing, via a prompt construction unit, a first prompt by appending the request, a default system prompt, the report context, and the data report as a first instruction string, the first instruction string including instructions to a first generative model, and the default system prompt being structured in sections each of which is defined with one or more predetermined purposes addressing different aspects of the instructions for the first generative model to follow when generating the insights; validating the first prompt using a second generative model by checking whether the first prompt is structured according to the sections that contain one or more predetermined purposes and whether the default system prompt is responsive to the report context; when the first prompt is validated by the second generative model, providing as an input the first prompt to the first generative model; generating, by the first generative model and according to the first prompt, an insight output; receiving as an output the insight output from the first generative model; and providing the insight output to display on the user interface of the client device.

An example non-transitory computer readable medium according to the disclosure on which are stored instructions that, when executed, cause a programmable device to perform functions of receiving, via a user interface of a client device, a request to generate insights of a data report associated with a service platform; providing a query for report context to display on the user interface of the client device; receiving, via the user interface of the client device, the report context; constructing, via a prompt construction unit, a first prompt by appending the request, a default system prompt, the report context, and the data report as a first instruction string, the first instruction string including instructions to a first generative model, and the default system prompt being structured in sections each of which is defined with one or more predetermined purposes addressing different aspects of the instructions for the first generative model to follow when generating the insights; validating the first prompt using a second generative model by checking whether the first prompt is structured according to the sections that contain one or more predetermined purposes and whether the default system prompt is responsive to the report context; when the first prompt is validated by the second generative model, providing as an input the first prompt to the first generative model; generating, by the first generative model and according to the first prompt, an insight output; receiving as an output the insight output from the first generative model; and providing the insight output to display on the user interface of the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for providing AI-based structured meta prompt generation are implemented.

FIGS. 2A-2B are conceptual diagrams of the AI-based structured meta prompt generation of the system of FIG. 1.

FIGS. 3A-3D are example user interfaces of an AI-based structured meta prompt generation solution that implements the techniques described herein.

FIG. 4 is a flow chart of an example process for providing AI-based structured meta prompt generation, according to the techniques disclosed herein.

FIG. 5 is a block diagram showing an example software architecture, various portions of which is used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

The complexity of service platform data reports depends on various factors like the size and complexity of services offered by a service platform, the tools and functionalities involved, and the like. Manually crafting meta prompts for different kind of data reports with respect to various platform services is incredibly time consuming, not scalable, and vulnerable to introducing security and compliance issues.

It is nearly impossible to create a generalized meta prompt using typical prompt engineering due to the wide diversity of content and behaviors involved in different service data reports. The manual meta prompt crafting cannot be done at scale. To combat these problems, a structural framework for AI-based meta prompt generation has be developed to generate meta prompts automatically and efficiently using generative model(s), thereby reducing the meta prompt generation time and resources thereby generating data report insights.

The structural framework for AI-based meta prompt generation includes discrete sections/components, each with defined purpose(s), for example, Role, Task, Rules, Example output, Thought process, Output format, Report context, and the like. In one embodiment, the structural framework for AI-based meta prompt generation supports insight generation out of data reports for cloud service tenants. For example, an application or a built-in function (“Get Insights”) applying an AI-based meta prompt generation pipeline (i.e., a meta prompt builder) takes large csv and json reports as inputs and generate natural language insights, identify trends, potential risks, and opportunities to optimize a cloud service based on the insights, and provides recommended actions for cloud service administrator(s) to take in response to the findings. The AI-based meta prompt generation pipeline is based on prompt engineering for structuring a meta prompt into sections with specific purposes that address different aspects of the instructions that Get Insights needed to follow when generating its response based on a default system prompt and user-input report context needed for the AI model to accurately summarize and recognize patterns in the reports. The default system prompt is determined based on user data, such as the user's role, activities, preferences, and the like. For example, the default system prompt includes sections of Role, Task, Rules, Example output, Thought process, and Output format. By validating whether the meta prompt is structured according to the sections that contain one or more predetermined purposes and whether the default system prompt is responsive (e.g., contextually relevant) to the report context, the pipeline constructs efficient and effective final prompts submitted to a generative model for generating report insights. The term “contextually relevant” refers to the content of the default system prompt is appropriate, meaningful, logically connected, and consistent with the report context, optionally the default system prompt is well-structured and informative based on the report context. For instance, the AI-based meta prompt generation pipeline can apply a generative model to interpret the user's intent (e.g., based on service usage data, user activity data, user preference data, user profile data, and the like) and extract relevant keywords or phrases from the report context, and then determine whether the default system prompt is appropriate, meaningful, and informative based on the user's intent and/or the extracted keywords or phrases. When the default system prompt is not responsive to the report context, the generative model can access and process information (e.g., service usage data, user activity data, user preference data, user profile data, and the like) to generate or retrieve another default system prompt that is responsive to the report context. The generative model can dynamically generate the other default system prompt based on changes in the context or new information provided.

In addition, the pipeline adapts the default system prompt with user input(s) addressed to respective section(s) to refine the final prompt. The user input(s) is abstracted and secured by new user interactive components based on the structural framework so that the input(s) is safely used in building the final prompt. By analogy, the pipeline apply the generative model to validate whether the default system prompt is responsive to the user input(s), before submitting the final prompt to the generative model for generating report insights.

Although various embodiments are described with respect to structured meta prompt generation based on a large language mode (LLM), it is contemplated that the approach described herein may be based other AI models depending on the input and output data type/format requirements (e.g., text, audio, diagrams, videos, and the like) as well as other considerations.

Although various embodiments are described with respect to applying AI-based structured meta prompt generation in a content and knowledge management admin platform, it is contemplated that the approach described herein may be applied in other service platforms.

A technical benefit of the approach provided herein is to automatically generate structured meta prompts for generating data report insights using AI, thereby supporting users to generate data report insights without awareness of the meta prompts, by plugging in customer data, prompt engineering, and AI models. The approach thus builds meta prompt for users behind the scene, and frees users from learning prompt engineering, yet still generate data report insights.

Another technical benefit of this approach is to invite user input to generate structured meta prompts for generating data report insights using AI, thereby supporting users with tools to build efficient meta prompts towards data report insights, by plugging in the user input, customer data, prompt engineering, and AI models.

Another technical benefit of this approach is to explore the ideal model to include in the meta prompt for a specific data scenario.

Another technical benefit of this approach is to provide experimental experiences for prompt building with data report selection visualization through slicer and dicer as well as data report insight visualization via diagrams, thereby obtaining immediate user feedback.

Another technical benefit of this approach is to provide a prompt building playground via block programming to administrators to intuitively enter their inputs for prompt building towards Get insights.

Yet, another technical benefit of this approach is to store the meta prompts for daily/periodic insight reports. These and other technical benefits of the techniques disclosed herein will be evident from the discussion of the example implementations that follow.

As used herein, the term “structural framework for AI-based meta prompt generation” includes discrete sections/components, each with defined purpose(s), for example, Role (that defines the system's persona and high-level purpose), Task (that defines the specific action the system performs), Rules (that specifies how the task should be accomplished, including guardrails to prevent harmful output), Example output (that gives the system an example of what its ideal output should look like), Thought process (that breaks down the example so the system understands what makes it ideal and replicate the pattern accordingly), Output format (that defines specific formatting requirements), Report context (that provides additional information to help the system analyze the report), and the like.

As used herein, the term “insights” of a data report refers to the hidden meaning or understanding extracted from the data report after analysis. It's not just the raw data itself, but rather the conclusions and interpretations that provide actionable information.

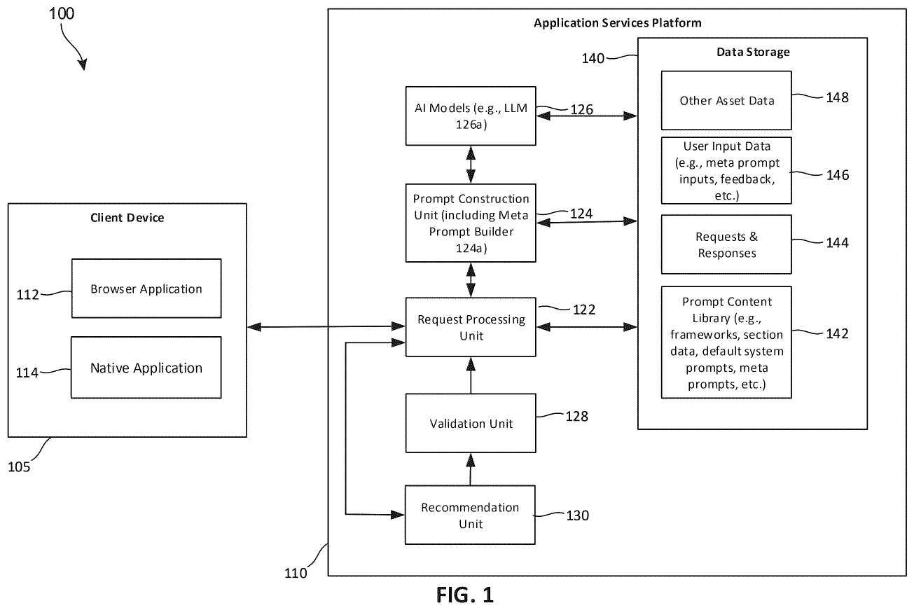

FIG. 1 is a diagram of an example computing environment 100 in which the techniques herein is implemented. The example computing environment 100 includes a client device 105 and an application services platform 110. The application services platform 110 provides one or more cloud-based applications and/or provides services to support one or more web-enabled native applications on the client device 105. These applications may include but are not limited to cloud service applications, file management applications, presentation applications, website authoring applications, collaboration platforms, communications platforms, and/or other types of applications in which users may create, view, and/or modify various types of service data report insights. In the implementation shown in FIG. 1, the application services platform 110 applies generative AI to automatically generate meta prompts for generating data report insights upon user demand, according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

The client device 105 includes a native application 114 and a browser application 112. The native application 114 is a native application, in some implementations, which enables AI-based meta prompt generation that supports data report insight generation. The native application utilizes services provided by the application services platform 110 including but not limited to creating, viewing, and/or modifying various types of service data report insights. For instance, the native application 114 is an enterprise collaboration and document management application (e.g., SharePoint®) that allows the enterprise employees to create, store, organize, and share information within their teams via a centralized location. Its administrators play a crucial role in managing and maintaining the platform environment within the enterprise.

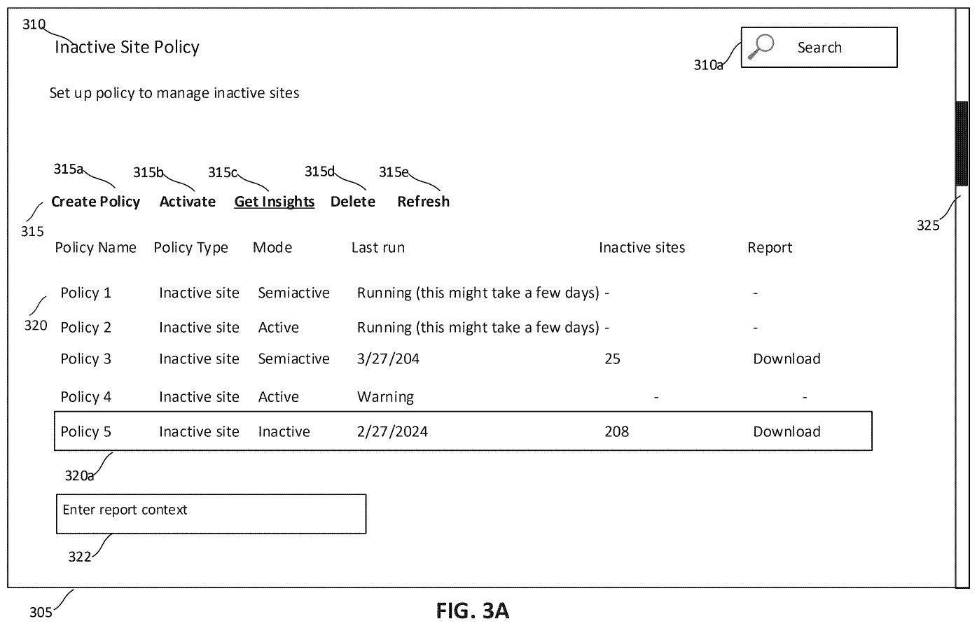

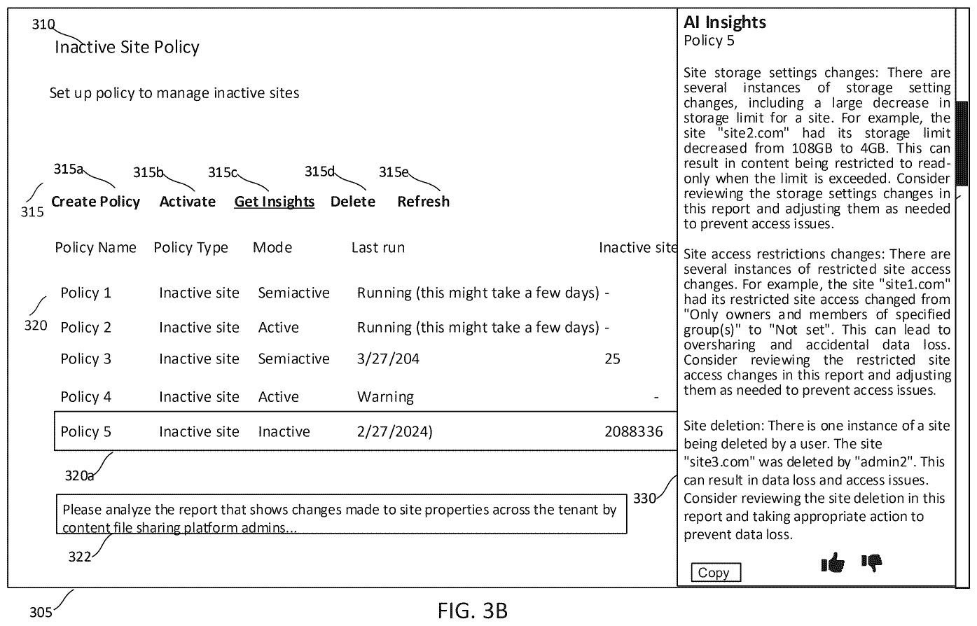

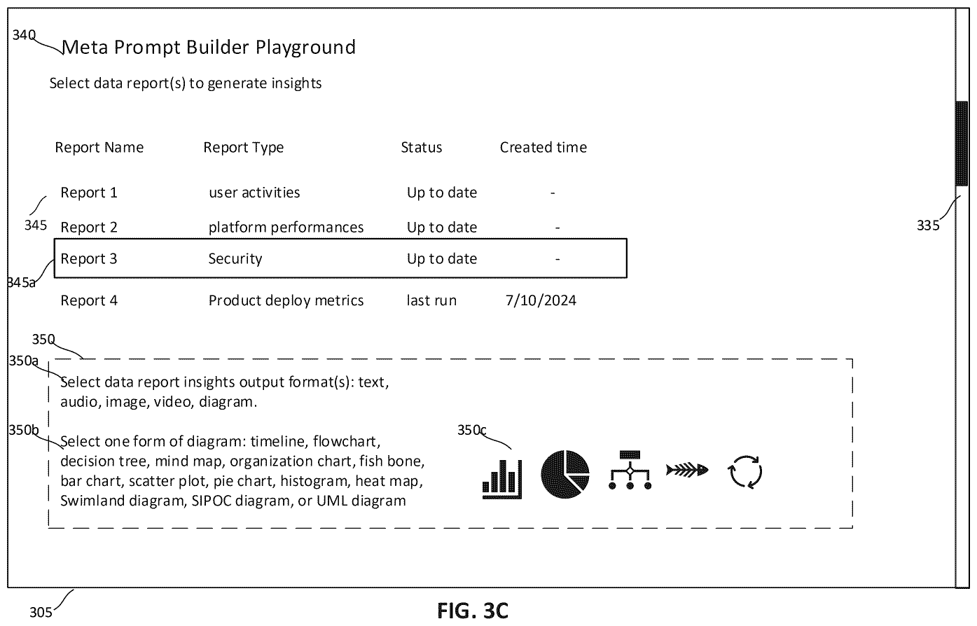

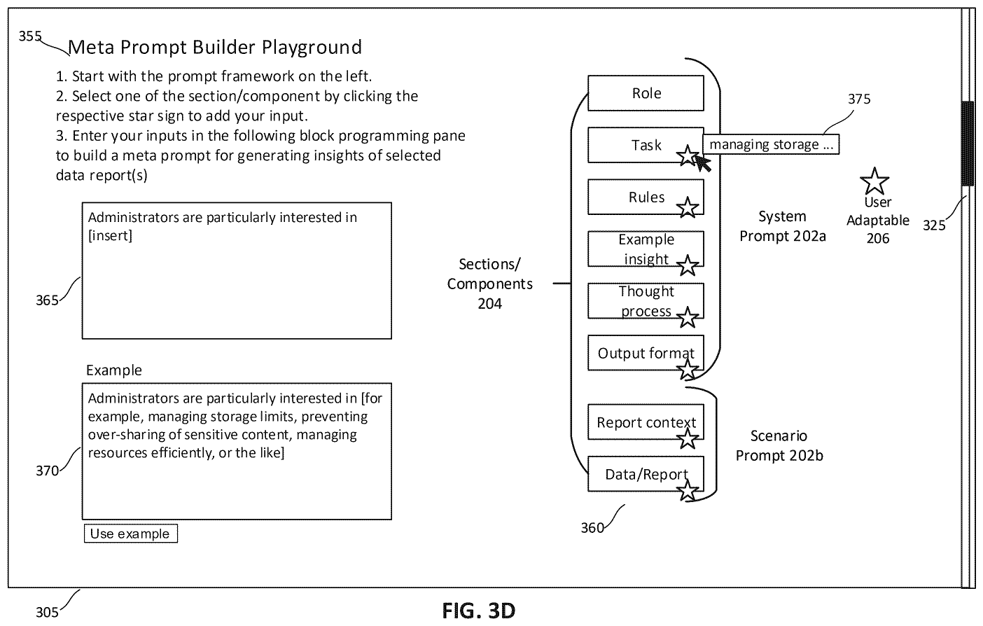

The native application 114 implements a user interface 305 shown in FIGS. 3A-3D in some implementations. In other implementations, the browser application 112 is used for accessing and viewing web-based content provided by the application services platform 110. In such implementations, the application services platform 110 utilizes one or more web applications, such as the browser application 112, that enables users to capture, view, and/or modify data report insights without prompt engineering. The browser application 112 implements the user interface 305 shown in FIGS. 3A-3D in some implementations. The application services platform 110 supports both the native application 114 and the browser application 112 in some implementations, and the users may choose which approach best suits their needs.

The administrators perform a lot of functions, such as implementing backup and recovery strategies to protect enterprise data and ensure business continuity. For example, they schedule and perform regular backups of content file sharing sites and databases and facilitate data recovery in case of any issues. In addition, the administrators monitor system performance, diagnose and troubleshoot issues, and implement performance tuning techniques to optimize the content file sharing environment. They also monitor server health, resource usage, and capacity planning. Moreover, the administrators ensure the security and compliance by implementing security controls, managing user permissions, and enforcing data protection policies. These functions require the administrators to monitor a lot of data reports.

The application services platform 110 includes a request processing unit 122, a prompt construction unit 124, AI model(s) 126 (e.g., a LLM 126a), a validation unit 128, a recommendation unit 130, a data storage 140, and moderation services (not shown).

At a meta prompt building stage, the request processing unit 122 is configured to receive a user request from the native application 114 and/or the browser application 112 of the client device 105. The user request may include but are not limited to a request to create one or more types of data report insights. In this case, the user selects data report(s) of interest.

A prompt content library 142 (e.g., frameworks, section data, default system prompts, meta prompts, and the like), requests and responses 144, user input data 146 (e.g., meta prompt inputs, feedback, etc.), and other asset data 148 can be stored in the data storage 140. The user input data 146 (e.g., meta prompt inputs, feedback, and the like) is tentatively linked with a user ID during a user session and saved in a cache. After the user session, user input data 146 is de-linked form the user ID as metadata of the meta prompt, and the resulted mate prompt is saved in the prompt content library 142.

The data storage 140 is physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCI), network virtualization and software-defined networking (SDN), container storage, and the like.

In an example, the application services platform 110 can store the system data separately from meta prompt data, to reduce the risk of unintentionally leaking sensitive information. The application services platform 110 can limit access to the meta prompt data and the system data. The application services platform 110 can also implement proper access controls, strong authentication, and authorization mechanisms to ensure that only authorized personnel can interact with the meta prompt data and the system data.

The application services platform 110 can also run the AI-based structured meta prompt generation solution in a secure computing environment. Moreover, the application services platform 110 can employ robust network security, firewalls, and intrusion detection systems to protect against external threats. The application services platform 110 can encrypt the system data and any data in transit. The application services platform 110 can also employ encryption standards for data storage and data transmission to safeguard against data breaches.

Moreover, the application services platform 110 can implement strong security measures around the AI-based structured meta prompt generation solution itself, such as regular security audits, code reviews, and ensuring that the disabled test file is up-to-date. The application services platform 110 can periodically audit the AI-based structured meta prompt generation solution's usage and access logs, to detect any unauthorized or anomalous activities. The application services platform 110 can also ensure that any use of the AI-based structured meta prompt generation solution complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

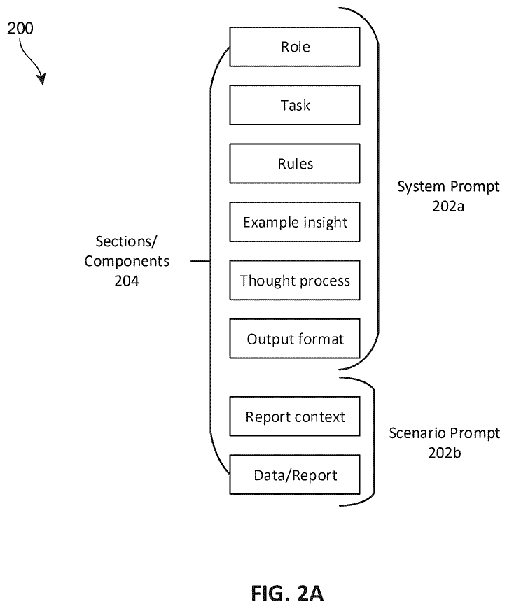

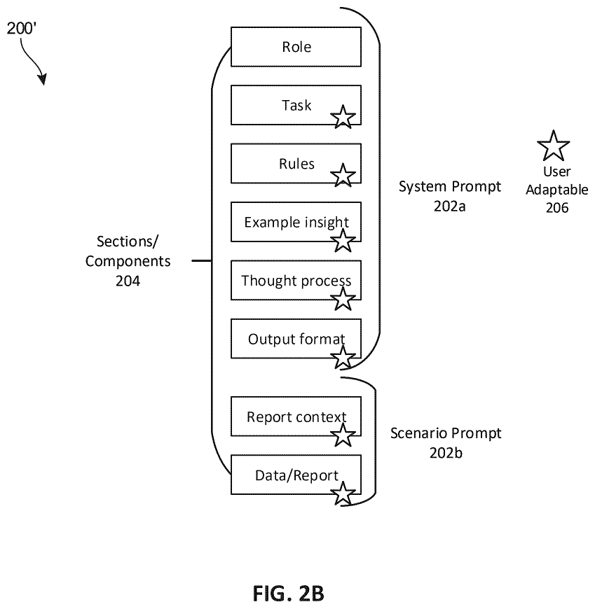

The AI-based meta prompt generation pipeline leverages the advanced capabilities of AI models (e.g., the LLM 126a) to generate structured meta prompts that supports data report insight generation with optional user input. FIG. 2A is a conceptual diagram of the structural framework 200 for AI-based meta prompt generation of the system of FIG. 1. By way of example, the structural framework 200 includes a system prompt 202a and a scenario prompt 202b. The system prompt 202a includes sections/components 204 of Role, Task, Rules, Example output, Thought process, and Output format, and instructions that the generative model(s) 126 will follow every time it runs. In one endowment, the sections/components 204 of the system prompt 202a contains default settings, i.e., a default system prompt of a meta prompt. In some implementations, the AI-based meta prompt generation pipeline generates or retrieves a default system prompt for a particular service platform (e.g., a cloud-based file sharing platform), based on service usage data, user activity data, user preference data, user profile data, and the like. Alternatively or concurrently, the AI-based meta prompt generation pipeline generates or retrieves a default system prompt based on the data report context (provided by the user), to increase processing speed.

The scenario prompt 202b of a meta prompt includes sections/components 204 of Report context, and Data/Report, and instructions and information specific to the data report(s) of interest and the report data. In this embodiment, all the user has to do is to activate an “Get Insights” function and provide the report context, the AI-based meta prompt generation pipeline will automatically generate the meta prompt behind the scene (without any user input besides the initial user request and the report context). As the data report insights are generated behind the scene, the user is not aware of the meta prompt or the final prompt input to the LLM 126a to generate the data report insights.

In other implementations, the user does not necessarily understand which data reports to use or study, and may not know how to work with AI models, the AI-based meta prompt generation pipeline can determine the data report(s) for generating insights based on the user context, for example, the data report(s) the user is viewing, viewed recently, and the like. In another embodiment, the pipeline uses a default data report stored in the system to generate a meta prompt and then generate the insights of the default data report.

Table 1 lists guardrail elements incorporated into the structural framework 200 for ensuring responsible and effective use of LLMs. Optionally, Table 1 lists guardrail elements regarding user interface (UX) patterns/guidelines that are incorporated into the structural framework 200.

TABLE 1

| | |
|---|---|
| - | System Role: You are an AI assistant that helps content file sharing |
| | platform Administrators to manage could storages and content file |
| | sharing platform online sites and other resources efficiently. |
| - | Tell AI model the source data and explain the scenario. |
| - | Specify the output: how much detail, the format, what to focus on, etc. |
| - | Prepare the data. Be aware of the token limit. Convert JSON/CSV |
| | report to a string |
| - | Turn off the talkative/verbose nature of the model. Best efforts without |
| | further clarification. |
| - | Control the hallucination. (Temperate=0.2, no more than 0.4) |

For example, based on the guardrail elements in Table 1 and a selected data report, the AI-based meta prompt generation pipeline extracts from a selected default system prompt in Table 2 three sections (e.g., Role, Task, Rules) of the structural framework 200 of FIG. 2A as shown in Table 3, for example, by improving vague language and undefined terms (e.g., LLM doesn't know what “top 3” “insights,” or “abnormal activity” mean, unless they are defined and/or given with an example), inconsistent terminology (e.g., service platform Administrator vs service platform admin), format that is not ideal for scaling, iteration, or testing, and the like.

TABLE 2
System prompt: You are an AI assistant that helps content file sharing
platform Administrators to manage content file sharing platform sites and
other resources efficiently.
The user will provide a set of data and you will help them gain insights.
You will summarize your findings and provide insights. You will limit
your sharing to top 3 findings.

TABLE 3
Role:
You are a content file sharing platform administration expert...
Task:
Analyze a report provided by the user...
Rules:
Do not make up information that is not in the report given by the user...

By analogy, the AI-based meta prompt generation pipeline extracts from a user-provided report context in Table 4 six bullet points of the Report context section of the structural framework 200 of FIG. 2A as shown in Table 5.

TABLE 4
Report context: Please analyze the report that shows changes made to site properties across
the tenant by content file sharing platform admins. The admins are particularly concerned
about abnormal activities, such as a decrease in the owner count, an increase in the
membership count, enabling external sharing on confidential sites, and other activities that
could lead to oversharing. Can you provide specific insights, including names, URLs, or
permission types, that could help the admins identify and address these issues? Here is the
data which is CSV: {file.csv}

TABLE 5
#Report context
- Report format is CSV
-This report shows changes made to site properties across the tenant by content file sharing
platform admins. “Changes made by” is followed by an account that did “Action”
-“Resource” is an entity affected by “Action”
-Example of settings in order of least strict to most: Anyone, New and existing guests,
Existing guests, Only people in your organization, Only owners and members, Specific
people, People with existing access.
-Example of information barriers modes in order from least strict to most strict: Open, Owner
moderated, Implicit, Explicit
- Restricted site access is least strict when it's “Not set” or when a specified group doesn't
exist.

The AI-based meta prompt generation pipeline generates section data (e.g., Table 3, Table 5) of the structural framework 200 of FIG. 2A, and combines the section data with the data report(s) into a final/system prompt that is sent to the LLM 126a to generate insights of the data report(s), even though the user has no knowledge of any AI models in the system. The pipeline applies two level of validation: one by another independent generative model based on responsiveness (e.g., contextual relevance), and the other by the user (e.g., based on content relevance, whether the report insights were what the user is interested). The other generative model has a separate workflow to avoid bias, and validates the meta prompt by checking whether the meta prompt is structured in the sections (e.g., role, task, rule, example output, thought process, output format, and report context) containing one or more predetermined purposes (e.g., as listed in Table 3) or missing information therein. The other generative model also checks whether the default system prompt is responsive to the report context. Alternatively or concurrently, the other generative model checks whether the final prompt meets a token limit, responsible AI guidelines, and the like. The validated meta prompt is sent to a generative model for generating report insights. In addition, the validated meta prompt is saved in a library for later (e.g., periodically) deployment for the user. Table 6 lists a full sample meta prompt generated by the AI-based meta prompt generation pipeline.

TABLE 6
# Role:
-You are a service platform Administration expert.
-You are an informative, warm, simple, to the point, and helpful assistant to other service
platform Administrators.
# Task:
- You will be given a report containing pertinent information to service platform
administrators. Your job is to summarize this information and provide insights.
- The report you will analyze is not necessarily the entire file, it may only be a section of the
file.
- content file sharing platform administrators are particularly interested in managing storage
limits, preventing over-sharing of sensitive content, and managing resources efficiently.
You **must** generate insights based on the rules below.
# Rules to follow:
- Today's date is 02-27-2024
- Do not make up information that is not in the report given by the user. Insights should only
be based on information in the report given by the user.
Here is an example insight:
--Storage setting changes: There are several instances of storage setting changes, including
a large decrease in storage limit for a site. For example, the site ″HR″ had its storage limit
decreased from 108GB to 2GB. This can result in content being restricted to read-only when
the limit is exceeded. Consider reviewing the storage settings changes in this report and
adjusting them as needed to prevent access issues.
# Thought process
-The header ′Storage setting changes:’ is a short summary of the insight
-The pattern ′There are several instances of storage setting changes, including a large
decrease in storage limit for a site′ describes a common theme found in the data.
- The evidence ′For example, the site ″HR″ had its storage limit decreased from 108GB to
2GB. This can result in content being restricted to read-only when the limit is exceeded.′ is
data extracted from the report that highlights the pattern.
- The recommended action ′Consider reviewing the storage settings changes in this report
and adjusting them as needed to prevent access issues.’ represents a follow up from the
insight.
# Output format:
-Directly return an unordered bulleted list of up to 3 insights. Do not include an intro
sentence.
- Output **must** be in a unordered bulleted list. Do not number the output.
- Output **must not** contain any inappropriate or harmful content.
- Output **must not** be more than 3 bullet points
#Report context
- Report format is CSV
-This report shows changes made to site properties across the tenant by content file sharing
platform admins. ″Changes made by″ is followed by an account that did ″Action″
-″Resource″ is an entity affected by ″Action″
-Example of settings in order of least strict to most: Anyone, New and existing guests,
Existing guests, Only people in your organization, Only owners and members, Specific
people, People with existing access.
-Example of information barriers modes in order from least strict to most strict: Open, Owner
moderated, Implicit, Explicit
- Restricted site access is least strict when it's ″Not set″ or when specified group doesn't exist.
#Important patterns to look for
- Changes from more strict to less strict settings made by the same user. This could lead to
oversharing. For example, at least one user change site access restriction to ″Not set″ on
multiple sites in this set of report data.
- Changes that can lead to accidental data loss, like the deletion of many sites by one user
- Changes that can lead to limited site access, such as archiving a significant number of sites,
or large changes made to storage settings. For example, a large decrease in storage limit for
a site can result in content restricted to read-only when the limit is exceeded

In one embodiment, the AI-based meta prompt generation pipeline can rewrite the meta prompt for clarity and specificity via testing and iteration. For instance, the pipeline reviews/rewrite the meta prompt until it is clear, concise, and specific enough for the LLM 126a to understand, and it provides all the necessary information for the LLM 126a to complete the task.

When the user indicates that the insights of the data report (one example insights are listed in Table 7) are what the user is seeking, the AI-based meta prompt generation pipeline saves the meta prompt for future use. When the user indicates that the insights of the data report are not what the user is seeking, the pipeline provides a meta prompt builder playground for the user to iteratively test with different data reports until generating the accurate and relevant insights consistently.

TABLE 7
Based on the provided data, here are the top 3 insights:
• On February 1, 2024 at 11:06, the site https://site1.com no longer exists. This could be a
potential security concern, as it is unclear who deleted the site and why.
• On February 1, 2024 at 11:12, the restricted site access for the site
https://site1.com/sites/121212 was changed to “Only owners and members of specified
group(s) | Group(s): 0_site_with_3232323”. It is unclear what this group is and why it was
added, which could be a potential security concern.
• There were multiple instances where the site owners were changed, with the new value
being “Service Platform system”. While it is possible that this was an intentional change, it
is unusual and could be a potential security concern. The affected sites include
https://site1.com/sites/testing11 (multiple times) and https://site1.com/sites/testing11 ...

In one embodiment, the AI-based meta prompt generation pipeline can rewrite the insights for clarity and specificity via testing and iteration. For instance, the pipeline reviews/rewrite the insights in Table 7 until it is clear, concise, and specific enough for an administrator to understand, and it provides all the necessary information for the administrator to complete the actions as shown in Table 8.

TABLE 8
Site storage settings changes: There are several instances of storage setting changes,
including a large decrease in storage limit for a site. For example, the site “site2.com” had
its storage limit decreased from 108GB to 4GB. This can result in content being restricted to
read-only when the limit is exceeded. Consider reviewing the storage settings changes in this
report and adjusting them as needed to prevent access issues.
Site access restrictions changes: There are several instances of restricted site access changes.
For example, the site “site1.com” had its restricted site access changed from “Only owners
and members of specified group(s)” to “Not set”. This can lead to oversharing and accidental
data loss. Consider reviewing the restricted site access changes in this report and adjusting
them as needed to prevent access issues.
Site deletion: There is one instance of a site being deleted by a user. The site “site3.com”
was deleted by “admin2”. This can result in data loss and access issues. Consider reviewing
the site deletion in this report and taking appropriate action to prevent data loss.

In one embodiment, the AI-based meta prompt generation pipeline presents a block programming user interface (e.g., similar to Scratch®, Blockly®, Tynker®, and the like) for a user to build a meta prompt. For example, the block programming user interface is designed to make coding easier and more intuitive, especially for beginners. Instead of writing lines of text, a user can use graphical blocks that snap together to build a meta prompt according to the structural framework 200 of FIG. 2A.

For example, a block programming visual interface is displayed with pre-defined colorful blocks. A user can drag and drop the pre-defined blocks that represent different sections/components of a meta prompt (e.g., role, task, rule, example output, and the like), and then enter textual content that addresses different aspects of the instructions for the generative model to follow when generating the insights. While the user does not need to write complex code, the user needs to know the definitions of each section/component of a meta prompt according to the structural framework 200, and insert/remove content with respect to each section/component.

Beside blocks, the block programming visual interface can include a workspace for a user to drag and drop blocks to assemble a meta prompt, a snap-together functionality to connect blocks in a logical manner, a preview/run area to show the user the output meta prompt, and a toolbox holding all the available blocks for easy access. Since blocks snap together logically and handle syntax automatically, there is less chance of making errors compared to traditional coding. This makes it easier for beginners, especially non-technical product managers, to grasp the frame fundamentals.

Alternatively or concurrently, the AI-based meta prompt generation pipeline presents a slicing and dicing visualization interface (e.g., similar to SlicerDicer®) for a user to virtually slice and dice a plurality of data reports into the one or more data reports for generating the insights. Using the slicing and dicing visualization interface, users can find the data report(s) they need to generate insights, and then refine their searches on the fly to better understand the data report(s) they work with. For example, the interface includes a workspace for the user to examine trends, drill down to line-level details, and jump to related records to follow up. A slicer option provides buttons that the user can click to filter data reports which is used to display, whereas a dicer options provides a simple and visual way of applying filters to data reports in spreadsheet(s).

The user selects data report slice(s) the user is interested to study for insights. The AI-based meta prompt generation pipeline builds the meta prompt, and then the final prompt to send to the LLM 126a to generate insights, and present the insights immediately. Optionally, the user can choose a visualization for the insights that matches the user's needs, including vertical and horizontal bar graphs, line graphs, maps, tree map charts, and the like. The slicing and dicing visualization interface can show the insights using a variety of different measures, including totals, percentages, averages, variance, maximums, minimums, and the like. As discussed, the user can iteratively experiment/test with different data reports until generating the desired insights. The user can lock-down the desired insight generation, and requests the pipeline to process the same way and to generate the insights periodically.

In addition, the user can select the output format for the data report insights, such as text, audio, image, video, diagram, and the like. Example diagrams include timeline, flowchart, decision tree, mind map, organization chart, fish bone, bar chart, scatter plot, pie chart, histogram, heat map, Swimland diagram, SIPOC diagram (Suppliers, Inputs, Processes, Outputs, Customers), UML diagram (Unified Modeling Language), and the like.

FIG. 2B is a conceptual diagram for adapting the structural framework 200 of FIG. 2A with user inputs into another structural framework 200′ for AI-based meta prompt generation. In the embodiment, the structural framework 200′ is shown on the user interface 305 to intact with the user, and the user can input any sections marked with a star 206 in FIG. 2B, such as Role, Task, Rules, Example output, Thought process, and possibly Output format. The AI-based meta prompt generation pipeline generates the meta prompt further based on user input(s) with respect to the star-marked sections of a default system prompt. For example, the prompt construction unit 124 constructs a meta prompt by appending the request, a default system prompt, default report context, the user input(s), and the data report as a first instruction string. In other words, the pipeline adapts the default system prompt with user input(s) addressed to respective section(s) to refine the default system prompt. In addition, the pipeline validates whether the default system prompt is responsive to the user input(s), before submitting the final prompt to the generative model for generating report insights. In short, the pipeline enables users to build efficient prompting towards the insights of relevant data reports by plugging in the user input(s). Once the insights are generated, the pipeline invites the user to determine/validate whether the insights of the data report are what the user is seeking (e.g., content relevant). The pipeline enables the user to iterate via a report builder playground, until the user quits or gets satisfactory data report insights. Consequentially, the data report insights are generated with the user inputs adapted into the meta prompt building. The meta prompt and the final prompt are still generated without showing to the user.

In addition to the LLM 126a, and the other LLM for validating the meta prompt, the AI-based meta prompt generation pipeline can explore the best AI model to include in the meta prompt for a specific data scenario. For example, Recurrent Neural Networks (RNNs) are well-suited for analyzing sequential data like stock prices, sensor readings, or website traffic. They can learn patterns from past data and predict future values, allowing for tasks like anomaly detection or forecasting future trends. As another example, Variational Autoencoders (VAEs) are used to analyze synthetic medical images like X-rays or MRIs. As the field of generative models is constantly evolving, these models become more sophisticated, the pipeline can more innovatively apply different AI models in data report analysis across various domains.

For prompting evaluation, the AI-based meta prompt generation pipeline can evaluate the generated meta prompt based on user validation as discussed. Alternatively, the pipeline can evaluate the generated meta prompt with various data report inputs and see if the outputs consistently pass user validation and/or meet some evaluation criteria. The evaluation criteria include clarity and specificity (e.g., does the prompt clearly explain what the system wants the LLM to do? are there any ambiguous terms that could lead to misinterpretations?), relevance (e.g., does the response generated by the LLM address the prompt directly and stay on topic?), coherence (e.g., is the output well-structured, easy to understand, and logically consistent?), usefulness (e.g., does the response fulfill the system's purpose or provide valuable information in relation to the prompt?), and neutrality (e.g., is the output free from biases or prejudices present in the prompt itself?). The pipeline can also compare the performance of different meta prompts designed for the same data report(s). This helps identify which meta prompt yields the best results.

In some implementations, the AI-based meta prompt generation pipeline processes data reports with model token limits in mind. For example, in a divide+merge processing, the pipeline divides the data in a data report into data chunks, recursively and preliminarily processes/analyzes the data chunks, and merges analysis results into insights. In a sliding window processing, the pipeline applies a sliding window with overlaps of the data chunks (i.e., data chunks with a sharing sliding window threshold), to discover data patterns. The data patterns are missing from the divide+merge processing. The sliding window processing recursively and preliminarily processes/analyzes the data chunks with overlaps, and merges analysis results into insights. In a final processing, the pipeline may merge all chunks/sliding windows pattern results into a global input, and processes the pattern input. The preliminary pattern analysis extracts interesting patterns and identifies outliners (i.e., abnormal patterns).

In addition, the AI-based meta prompt generation pipeline can reduce the data in the data report via pruning with pattern programmed techniques and/or using an AI model. The pattern programmed techniques apply pre-defined patterns via rule-based filtering (e.g., data with well-defined structures or anomalies you want to eliminate), and/or regular expressions for text-based data. The AI model is a machine learning model with pattern recognition, such as decision trees, support vector machines (SVMs), and the like.

The AI-based meta prompt generation pipeline then stores preliminary pattern results for subsequent prompting towards a model token limit. In one embodiment, the pipeline adopts a model with a large token limit, for example, GPT-4 with a limit of 32,000 tokens (making it suitable for handling very long text sequences). In addition, the pipeline can apply prompt compression techniques to reduce the prompt size, such as the Iterative Token-level Prompt Compression (ITPC) algorithm. The ITPC algorithm starts by dividing the target prompt into several segments. A small language model, like GPT-2 or LLaMA, is used to compute the perplexity of each segment in the prompt. The ITPC algorithm then iteratively works through these segments by calculating the conditional probabilities and determines a compression threshold. The ITPC algorithm aims to maintain the semantic integrity of the prompt, even under high compression ratios, by carefully selecting which tokens to compress based on their calculated probabilities and information content.

In one embodiment, the AI-based meta prompt generation pipeline fine-tunes the generative model 126 (e.g., the LLM 126a) on an ongoing basis. The LLM 126a is updated periodically, such as by retraining on new data. Alternatively or concurrently, the pipeline can prune the LLM 126a, by reducing its size and computational cost while maintaining its performance. There are different pruning techniques for LLMs, such as magnitude pruning, Wanda®, and the like. These techniques identify and remove unimportant connections or parameters within the LLM 126a, making it smaller. Pruning can affect the LLM's performance on some tasks. As such, the pipeline finds a balance between size reduction and performance preservation.

FIG. 3A is a diagram of an example user interface 305 of an AI-based structured meta prompt generation solution that implements the techniques described herein. The user interface 305 is for content and knowledge management admin platform that acts as the central location for administrators to manage sites, content, security, and other settings, such as but not limited to SharePoint® admin center. However, the techniques herein for providing AI-based structured meta prompt generation are not limited to use SharePoint® Admin Center, and can be used in any service platform for managing content generated via applications including but not limited to presentation applications, website authoring applications, collaboration platforms, communications platforms, and/or other types of applications. Such an AI-based structured meta prompt generation solution can be a stand-alone application, or a plug-in of any application on a server, a cloud, or even a client device.

The user interface 305 includes a title pane 310, a control pane 315, a content pane 320, and a scrollbar 325. The content and knowledge management admin platform supports an administrator to create new content sharing sites, view existing ones, configure settings, and delete sites if needed. In one implementation, the title pane 310 includes a title “Inactive Site Policy” and an instruction of “Set up policy to manage inactive sites.” The title pane 310 also includes in search filed 310a.

The control pane 315 includes a create policy button 315a, an activate button 315b, a get insights 315c, a delete button 315d, and a refresh button 315c. The create policy button 315a can be selected to create a policy to manage inactive sites. The activate button 315b can be selected to activate a policy to manage inactive sites. The get insights 315c can be selected to generate data report insights without any user inputs. The delete button 315d can be selected to delete a policy to manage inactive sites. The refresh button 315e can be selected to refresh a policy to manage inactive sites.

The content pane 320 shows a list of five policies with the respective policy names, policy types, modes, last run time, relevant inactive sites, and associated data reports. In FIG. 3A, the user selects the get insights 315c and the policy 320a (“Policy 5”), to generate insights on the data report associated with the policy 320a that involves 208 active sites. The content pane 320 also shows a report context box 322 for the user to enter the relevant report context of the data report of interest (e.g., (“Policy 5”). The AI-based meta prompt generation pipeline processes the data report of the policy 320a according to the techniques provided herein to generate insights as shown in FIG. 3B. FIG. 3B shows report context of “Please analyze the report that shows changes made to site properties across the tenant by content file sharing platform admins . . . ” in the report context box 322.

In FIG. 3B, another content pane 330 popups over in the user interface 305 showing the insights of the data report (e.g., the data report insights listed in Table 8) associated with the policy 320a. The content pane 330 further shows a thumb up button, a thumb down button, and a copy button. The user can select the thumb up button to validate the data report insights, or the thumb down button to invalidate the data report insights. The user can select the copy button to copy the data report insights.

In some implementations, the system provides a feedback loop by augmenting thumbs up and thumbs down buttons for each set of AI-generated data report insights in the user interface 305. If the user dislikes a response, the system can ask why and use the input to improve the response. A thumbs down click could also prompt the user to indicate whether the response was too long, too short, missing information, and the like.

The user prompts, the responses, and the user feedback are submitted to the application services platform 110 to generate another response using the generative models 126 and/or to improve the generative models 126. The AI-based content generation thus incorporates user feedback in real-time or in substantially real-time, and allows user inputs via intuitive user interfaces.

FIG. 3C shows another example of the user interface 305 of a service platform in which the user is interacting with the service platform to create a meta prompt. The user interface 305 includes a title pane 340, a content pane 345, and a visualization pane 350. In this implementation, the title pane 340 includes a title “Meta Prompt Builder Playground” and an instruction of “Select data report(s) to generate insights.” The title pane 310 also includes in search filed 310a.

The Mata Prompt Builder Playground is designed to intake user inputs to meta prompt generation easier and more intuitive, especially for beginners (e.g., non-technical content sharing platform administrator). Instead of writing lines of text, a user uses graphical blocks that snap together to build a meta prompt according to a structural framework for AI-based meta prompt generation that works behind the scene to generate data report insights.

The content pane 345 shows a list of four data reports with the respective report names, report types, status, and created time. In FIG. 3C, the user selects a security data report 345a (“Report 3”), to generate its insights. The AI-based meta prompt generation pipeline processes the data report 345a according to the techniques provided herein.

The visualization pane 350 provides a data exploration and reporting tool for the selected data report. The user can select the data report(s) they need to investigate, and then select visualization option(s) on the fly to better understand the data report(s). The visualization pane 350 includes an instruction 350a: “Select data report insights output format(s): text, audio, image, video, diagram,” an instruction 350b: “Select one form of diagram: timeline, flowchart, decision tree, mind map, organization chart, fish bone, bar chart, scatter plot, pie chart, histogram, heat map, Swimland diagram, SIPOC diagram, or UML diagram,” and diagram icons 350c for the user to make a selection.

Continuing from the section of the security data report 345a, the user interface 305 in FIG. 3D includes a title pane 355, a prompt framework pane 360, a user input pane 365, and an example pane 370. In this implementation, the title pane 355 includes the title “Prompt Builder Playground” and instructions of “1. Start with the prompt framework on the left. 2. Select one of the section/component by clicking the respective star sign to add your input. 3. Enter your inputs in the following block programming pane to build a meta prompt for generating insights of selected data report(s).”

The prompt framework pane 360 shows the structural framework 200′ depicted in FIG. 2B that works behind the scene to generate data report insights. After the user selects a star sign next to the Task section of the structural framework 200′ in FIG. 3D, the AI-based meta prompt generation pipeline makes the user input pane 365 display a text template for Task, e.g., “Administrators are particularly interested in [insert]” based on the context of the security data report 345a, to invite the user to enter the user's interests with respect to the Task. The pipeline makes the example pane 370 display an example template for Task, e.g., “Administrators are particularly interested in [for example, managing storage limits, preventing over-sharing of sensitive content, managing resources efficiently, and the like]” corresponding to the text template in the user input pane 365. The user can enter his or her own interests, and/or use the examples shown in the example pane 370 by clicking a “use example” button.

Alternatively, the user can enter the interests via a block programming interface built in the prompt framework pane 360 in FIG. 3D. For example, after the user clicks the star sign next to the Task section of the structural framework 200′, an extension 375 of the Task block is shown for the user to enter the interest, e.g., “managing storage . . . ”

In some implementations, the application services platform 110 includes the moderation services that analyze prompt(s), user feedbacks, and responses generated by the generative models 126, to ensure that potentially objectionable or offensive content is not generated or utilized, as a part of the RAI implementation executed by the validation unit 128 using a generative model independent form the LLM 126a.

If potentially objectionable or offensive content is detected in the prompt(s), the user feedback, and the AI-generated responses, the moderation services provides a blocked content notification to the client device 105 indicating that the prompt(s), the user input data is blocked from forming the system prompt. In some implementations, the request processing unit 122 discards any user input data that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative models 126 as an input.

In one embodiment, the prompt construction unit 124 submits the prompt(s), and/or the system prompt to the moderation services to ensure that the prompt does not include any potentially objectionable or offensive content. The prompt construction unit 124 halts the processing of the prompt(s), and/or the system prompt in response to the moderation services determining that the prompt(s) and/or the responses includes potentially objectionable or offensive content. As discussed in the preceding examples, the moderation services generates a blocked content notification in response to determining that the prompt(s), and/or the system prompt includes potentially objectionable or offensive content, and the notification is provided to the native application 114 or the browser application 112 so that the notification is presented to the user on the client device 105. For instance, the user attempts to revise and resubmit the prompt(s). As another example, the system generates another system prompt after removing task data associated with the potentially objectionable or offensive content.

The moderation services can be implemented by a machine learning model trained to analyze the content of these various inputs and/or outputs to perform a semantic analysis on the content to predict whether the content includes potentially objectionable or offensive content. The moderation services can perform another check on the content using a machine learning model configured to analyze the words and/or phrase used in content to identify potentially offensive language/image/sound. The moderation services can compare the language used in the content with a list of prohibited terms/images/sounds including known offensive words and/or phrases, images, sounds, and the like. The moderation services can provide a dynamic list that can be quickly updated by administrators to add additional prohibited terms/images/sounds. The dynamic list is updated to address problems such as words or phrases becoming offensive that were not previously deemed to be offensive. The words and/or phrases added to the dynamic list is periodically migrated to the guard list as the guard list is updated. The specific checks performed by the moderation services vary from implementation to implementation. If one or more of these checks determines that the textual content includes offensive content, the moderation services can notify the application services platform 110 that some action should be taken.

In some implementations, the moderation services generates a blocked content notification, which is provided to the client device 105. The native application 114 or the browser application 112 receives the notification and presents a message on a user interface of the application that the user prompt received by the request processing unit 122 could not be processed. The user interface provides information indicating why the blocked content notification was issued in some implementations. The user attempts to refine a natural language prompt to remove the potentially offensive content. A technical benefit of this approach is that the moderation services provides safeguards against both user-created and model-created content to ensure that prohibited offensive or potentially offensive content is not presented to the user in the native application 114 or the browser application 112.

As mentioned, the application services platform 110 complies with privacy guidelines and regulations that apply to the usage of user input data included in the content to be semantically analyzed to ensure that users have control over how the application services platform 110 utilizes their data. The user is provided with an opportunity to opt into the application services platform 110 to allow the application services platform 110 to access the user input data and enable the generative models 126 to generate a response according to user consent. In some implementations, the first time that an application, such as the native application 114 or the browser application 112 presents the data analysis assistant to the user, the user is presented with a message that indicates that the user opts into allowing the application services platform 110 to use user input data included in the content to support the content generation functionality. The user opts into allowing the application services platform 110 to access all or a subset of user input data included in the meta prompt for generating data report insights. Furthermore, the user modifies their opt-in status at any time by selectively opting into or opting out of allowing the application services platform 110 from accessing and utilizing user input data from the content as a whole or individually.

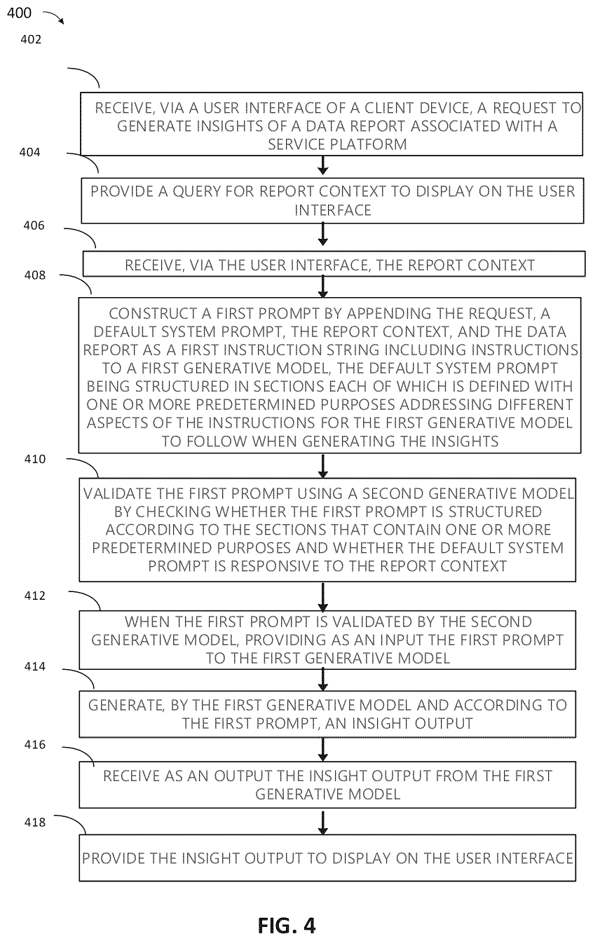

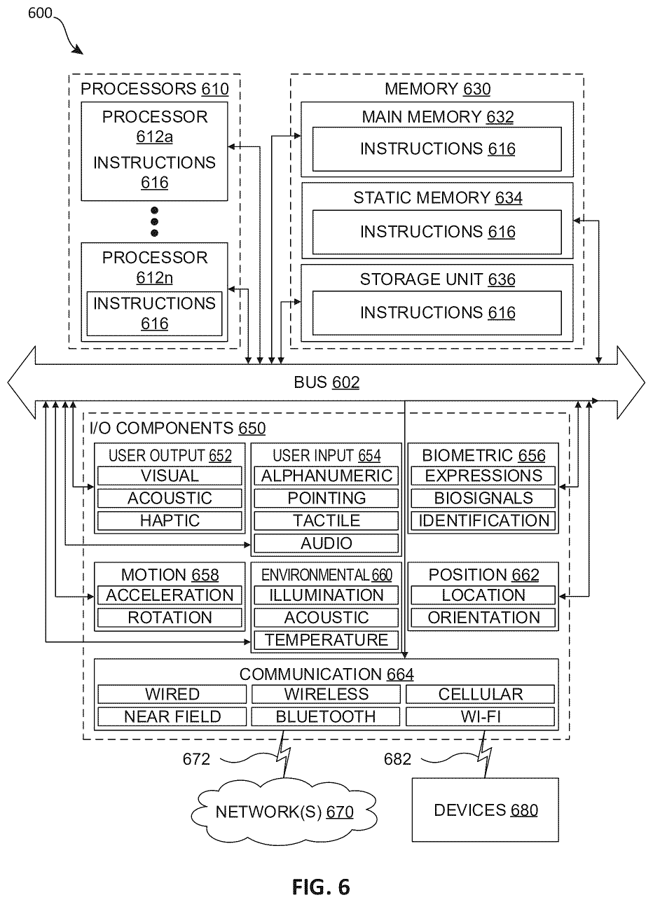

FIG. 4 is a flow chart of an example process for providing AI-based structured meta prompt generation, according to the techniques disclosed herein. The process 400 is implemented by the application services platform 110 or its components shown in the preceding examples. The process 400 is implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the application services platform 110. Although the process 400 is illustrated and described as a sequence of steps, it is contemplated that various embodiments of the process 400 is performed in any order or combination and need not include all the illustrated steps.

In one embodiment (e.g., FIG. 2A), for example, in step 402, the request processing unit 122 receives, via a user interface (e.g., the user interface 305) of a client device (e.g., the client device 105), a user request to generate insights (e.g., the insights listed in Table 7 or Table 8) of one or more data reports (e.g., the data reports on user activities, platform performances, security, product deployment metrics in FIG. 3C) associated with a service platform (e.g., a content and knowledge management service platform in FIG. 3A).

In step 404, the request processing unit 122 provides a query for report context (e.g., “Enter report context” in the report context box 322 in FIG. 3A) to display on the user interface 305 of the client device 105. In step 406, the request processing unit 122 receives, via the user interface 305, the report context (e.g., “Please analyze the report that shows changes made to site properties across the tenant by content file sharing platform admins . . . ” in the report context box 322 in FIG. 3B).

In step 408, a prompt construction unit (e.g., the prompt construction unit 124) constructs a first prompt (e.g., the meta prompt listed in Table 6) by appending the user request, a default system prompt, the report context, and the one or more data reports as a first instruction string. The first instruction string includes instructions to a first generative model (e.g., the LLM 126a). The default system prompt is structured in sections each of which is defined with one or more predetermined purposes (e.g., as listed in Table 3) addressing different aspects of the instructions for the first generative model to follow when generating the insights. For instance, the sections include role, task, rule, example output, thought process, output format, and report context (e.g., the structural framework 200 in FIG. 2A). The default system prompt is determined based on service usage data, user activity data, user preference data, user profile data, or the report context.

In step 410, the validation unit 128 validates the meta prompt using a second generative model (e.g., another LLM independent from the LLM 126a having a separate workflow thus avoiding bias) by checking whether the meta prompt is structured in the sections (e.g., role, task, rule, example output, thought process, output format, and report context) containing one or more predetermined purposes (e.g., as listed in Table 3) and whether the default system prompt is responsive (e.g., contextually relevant) to the report context. Alternatively or concurrently, the validation unit 128 validates the meta prompt by checking the meta prompt against at least one of a generative model token limit (e.g., set by the LLM 126a) or a responsible AI (RAI) guideline.

RAI principles guide the ethical development and use of AI throughout its lifecycle. This means ensuring AI respects human rights, is transparent and fair, prioritizes safety and security, protects privacy, and is accountable. Additionally, RAI emphasizes the importance of designing AI for human well-being and continuous improvement, to address potential biases and following ethical and legal considerations. RAI principles are implemented via content moderation services, hallucination control, using diverse datasets and mitigating bias, ensuring transparency through documentation and explanation of AI decisions, prioritizing user privacy with anonymization and data governance, implementing security measures throughout the AI lifecycle, and the like.

Continuing to step 412, when the meta prompt is validated by the second generative model, the prompt construction unit provides as an input the first prompt to the first generative model.

In step 414, the first generative model generates, according to the second prompt, an insight output. In step 416, the prompt construction unit receives an insight output from the first generative model.

In step 418, the request processing unit 122 provides the insight output to display on the user interface of the client device (e.g., the insights of the data report (e.g., the data report insights listed in Table 8) associated with the policy 320 in the content pane 330 in FIG. 3B). In another embodiment, the request processing unit 122 provides, to display on the user interface of the client device, an instruction for a user of the client device to validate whether the insight output contains the insights.

In one embodiment, when the first prompt is not validated by the second generative model, the request processing unit 122 iteratively determines another default system prompt based on the data associated with the user and validating the other default system prompt until the report context is responsive to the other default system prompt.

In another embodiment, when the meta prompt is not validated by the second generative model, the request processing unit 122 sends an insight generation failure message (e.g., “The system fails to generate data report insights”) to the client device for display. In another embodiment, when the meta prompt is not validated by the second generative model, the recommendation unit 130 fills in respective one or more sections (e.g., role, task, rule, example output, thought process, output format, and/or report context) with one or more predetermined purposes according to filling instructions, to provide a filled-in meta prompt. For instance, the filling instructions start from a default template of predetermined purposes per section, then grow into a library based on user feedback/validation. As another instance, the system can train a machine learning model to generate the filling instructions based on training data, then establish a filling instruction library for different scenarios, such as data reports on user activities, platform performances, security, business metrics, and the like.

In one embodiment, the request processing unit 122 receives, via the user interface of the client device, a user indication that the output is validated as containing the insights; stores the meta prompt in a library or database; and periodically works in conjunction with other units to generate the output as a periodic insight report for the user. Otherwise, the request processing unit 122 receives, via the user interface of the client device, a user indication that the output does not contain the insights; and sends an insight generation failure message (e.g., “The system fails to generate data report insights”) to the client device for display.

In another embodiment, the recommendation unit 130 identifies at least one of a trend, a potential risk, or an opportunity to optimize services of the service platform for the user based on the insights. The recommendation unit 130 then generates one or more action recommendations for the user based on the at least one of the trend, the potential risk, or the opportunity. The request processing unit 122 sends the one or more action recommendations to the client device for display.

In one embodiment with user inputs directed to section(s) of a default system prompt, the request processing unit 122 causes a presentation of a meta prompt structure including the sections on the user interface of the client device (e.g., the structural framework 200′ in FIG. 2B). The request processing unit 122 then receives, via the user interface, one or more section inputs (e.g., managing storage limits, preventing over-sharing of sensitive content, managing resources efficiently, and the like) by the user directed to one or more of the sections (e.g., by clicking a start mark next to the Task section as in FIG. 3D). The prompt construction unit adapts the default system prompt based on the one or more section inputs to the one or more of the sections respectively. By analogy, the validation unit 128 validates the adapted meta prompt using the second generative model by checking whether the default system prompt is responsive (e.g., contextually relevant) to the section input.

When the adapted meta prompt is validated by the second generative model, the prompt construction unit constructs an adapted first prompt by appending the adapted meta prompt, the user request, and the one or more data reports as an adapted first instruction string, the adapted first instruction string including instructions to the first generative model to generate the insights. The prompt construction unit provides as an input the adapted first prompt to the first generative model and receiving an adapted output from the first generative model. The request processing unit 122 sends the adapted output to the client device with an instruction for the user of the client device to validate whether the adapted output contains the insights.

In one embodiment, the request processing unit 122 causes a configuration of the user interface of the client device as a block programming user interface (e.g., by replacing each section boxes in FIG. 3D with a programming block). In this case, the presentation includes the sections (e.g., role, task, rule, example output, thought process, output format, and/or report context) presented as blocks configured to build the meta prompt, and the one or more inputs by the user are visually directed to one or more of the blocks on the user interface. In another embodiment, the request processing unit 122 causes a graphic presentation of a plurality of data reports (e.g., the list of data reports in FIG. 3C) including the data report on the user interface of the client device. The request processing unit 122 then receives, via the user interface, another input that virtually slices and dices the plurality of data reports into the data report to generate the insights (e.g., the user selection in FIG. 3C virtually slicing the security data report from the list of data reports).

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

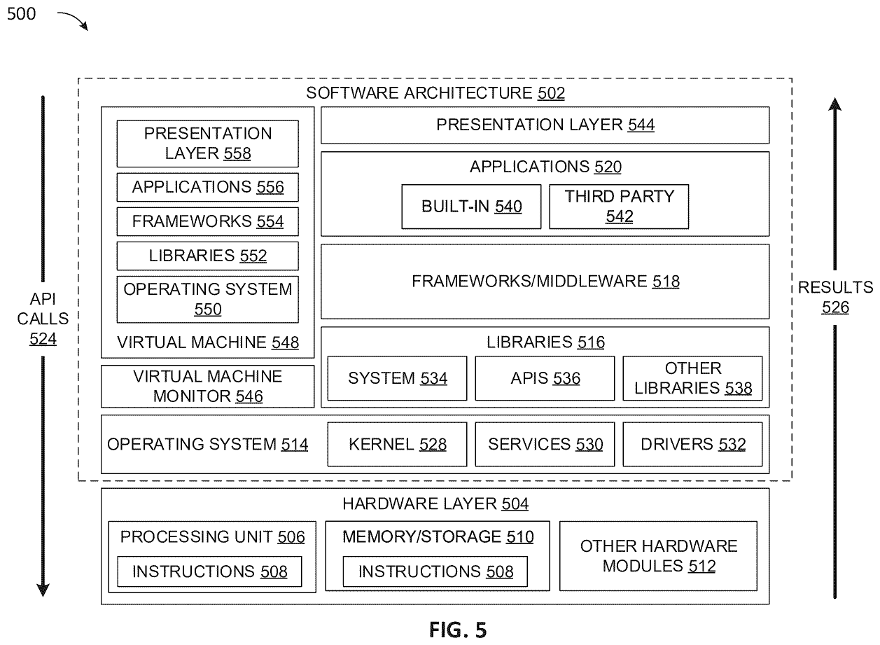

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform following operations:
receiving, via a user interface of a client device, a request to generate insights of a data report associated with a service platform;
providing a query for report context to display on the user interface of the client device;
receiving, via the user interface of the client device, the report context;
constructing, via a prompt construction unit, a first prompt by appending the request, a default system prompt, the report context, and the data report as a first instruction string, the first instruction string including instructions to a first generative model, and the default system prompt being structured in sections each of which is defined with one or more predetermined purposes addressing different aspects of the instructions for the first generative model to follow when generating the insights;
validating the first prompt using a second generative model by checking whether the first prompt is structured according to the sections that contain one or more predetermined purposes and whether the default system prompt is responsive to the report context;
when the first prompt is validated by the second generative model, providing as an input the first prompt to the first generative model;
generating, by the first generative model and according to the first prompt, an insight output;
receiving as an output the insight output from the first generative model; and
providing the insight output to display on the user interface of the client device.

2. The data processing system of claim 1, wherein the machine-readable storage medium further includes instructions configured to cause the processor alone or in combination with other processors to perform of:
when the first prompt is not validated by the second generative model, providing an insight generation failure message to display on the user interface of the client device.

3. The data processing system of claim 1, wherein the machine-readable storage medium further includes instructions configured to cause the processor alone or in combination with other processors to perform of:
when the first prompt is not validated by the second generative model, adapting, by the prompt construction unit according to filling instructions, the first prompt by filling in respective one or more sections with one or more predetermined purposes.

4. The data processing system of claim 1, wherein the machine-readable storage medium further includes instructions configured to cause the processor alone or in combination with other processors to perform of:
providing, to display on the user interface of the client device, an instruction for a user of the client device to validate whether the insight output contains the insights.

5. The data processing system of claim 4, wherein the machine-readable storage medium further includes instructions configured to cause the processor alone or in combination with other processors to performs of:
receiving, via the user interface of the client device, an indication that the insight output is validated as containing the insights;
storing the first prompt in a library; and
periodically generating the insight output as a periodic insight report.

6. The data processing system of claim 4, wherein the machine-readable storage medium further includes instructions configured to cause the processor alone or in combination with other processors to performs of:
receiving, via the user interface of the client device, an indication that the insight output is validated as containing the insights;
identifying at least one of a trend, a potential risk, or an opportunity to optimize a service of the service platform based on the insights;
generating an action recommendation based on the at least one of the trend, the potential risk, or the opportunity; and
providing the action recommendation to display on the user interface of the client device.

7. The data processing system of claim 4, wherein the machine-readable storage medium further includes instructions configured to cause the processor alone or in combination with other processors to performs of:
receiving, via the user interface of the client device, an indication that the insight output does not contain the insights; and
providing an insight generation failure message to display on the user interface of the client device.

8. The data processing system of claim 1, wherein the machine-readable storage medium further includes instructions configured to cause the processor alone or in combination with other processors to perform:
causing a presentation of a prompt structure including the sections on the user interface of the client device;
receiving, via the user interface, a section input directed to one of the sections, wherein constructing the first prompt includes appending the first instruction string with the section input; and
adapting, by the prompt construction unit and according to the section input, the first prompt,
wherein the sections include role, task, rule, example output, thought process, and output format, and
wherein validating the first prompt includes checking whether the default system prompt is responsive to the section input.

9. The data processing system of claim 8, wherein the machine-readable storage medium further includes instructions configured to cause the processor alone or in combination with other processors to perform:
causing a configuration of the user interface of the client device as a block programming user interface,
wherein causing the presentation of the first prompt structure includes causing the sections presented as blocks configured to build the first prompt, and the section input as visually directed to one of the blocks on the user interface.

10. The data processing system of claim 8, wherein the machine-readable storage medium further includes instructions configured to cause the processor alone or in combination with other processors to perform:
causing a graphic presentation of a plurality of data reports including the data report on the user interface of the client device; and
receiving, via the user interface, another input that virtually slices and dices the plurality of data reports into the data report to generate the insights.

11. The data processing system of claim 1, wherein the machine-readable storage medium further includes instructions configured to cause the processor alone or in combination with other processors to perform:
determining the default system prompt based on at least one of service usage data, user activity data, user preference data, user profile data, or the report context.

12. The data processing system of claim 1, wherein the machine-readable storage medium further includes instructions configured to cause the processor alone or in combination with other processors to perform:
when the first prompt is not validated by the second generative model, iteratively determining another default system prompt based on the data associated with the user and validating the other default system prompt until the report context is responsive to the other default system prompt.

13. A method comprising:
receiving, via a user interface of a client device, a request to generate insights of a data report associated with a service platform;
causing a presentation of a structure of a meta prompt on the user interface, wherein the structure includes sections;
receiving, via the user interface, an input directed to one of the sections;
constructing, via a prompt construction unit, a first prompt by appending the request, a default system prompt, default report context, the input, and the data report as a first instruction string, the first instruction string including instructions to a first generative model, and the default system prompt being structured in sections each of which is defined with one or more predetermined purposes addressing different aspects of the instructions for the first generative model to follow when generating the insights;
validating the first prompt using a second generative model by checking whether the first prompt is structured according to the sections that contain one or more predetermined purposes and whether the default system prompt is responsive to the input;
when the first prompt is validated by the second generative model, providing as an input the first prompt to the first generative model;
generating, by the first generative model and according to the first prompt, an insight output;
receiving as an output the insight output from the first generative model; and
providing the insight output to display on the user interface of the client device.

14. The method of claim 13, further comprising:
causing a configuration of the user interface of the client device as a block programming user interface,
wherein causing the presentation of the first prompt structure includes causing the sections presented as blocks configured to build the first prompt, and the section input as visually directed to one of the blocks on the user interface.

15. The method of claim 13, further comprising:
causing a graphic presentation of a plurality of data reports including the data report on the user interface of the client device; and
receiving, via the user interface, another input that virtually slices and dices the plurality of data reports into the data report to generate the insights.

16. The method of claim 13, further comprising:
providing, to display on the user interface of the client device, an instruction for a user of the client device to validate whether the insight output contains the insights.

17. A non-transitory computer readable medium on which are stored instructions that, when executed, cause a programmable device to perform functions of:
receiving, via a user interface of a client device, a request to generate insights of a data report associated with a service platform;
providing a query for report context to display on the user interface of the client device;
receiving, via the user interface of the client device, the report context;
constructing, via a prompt construction unit, a first prompt by appending the request, a default system prompt, the report context, and the data report as a first instruction string, the first instruction string including instructions to a first generative model, and the default system prompt being structured in sections each of which is defined with one or more predetermined purposes addressing different aspects of the instructions for the first generative model to follow when generating the insights;
validating the first prompt using a second generative model by checking whether the first prompt is structured according to the sections that contain one or more predetermined purposes and whether the default system prompt is responsive to the report context;
when the first prompt is validated by the second generative model, providing as an input the first prompt to the first generative model;
generating, by the first generative model and according to the first prompt, an insight output;
receiving as an output the insight output from the first generative model; and
providing the insight output to display on the user interface of the client device.

18. The non-transitory computer readable medium of claim 17, wherein the instructions when executed, further cause the programmable device to perform:
when the first prompt is not validated by the second generative model, providing an insight generation failure message to display on the user interface of the client device.

19. The non-transitory computer readable medium of claim 17, wherein the instructions when executed, further cause the programmable device to perform:
when the first prompt is not validated by the second generative model, adapting, by the prompt construction unit according to filling instructions, the first prompt by filling in respective one or more sections with one or more predetermined purposes.

20. The non-transitory computer readable medium of claim 17, wherein the instructions when executed, further cause the programmable device to perform:
providing, to display on the user interface of the client device, an instruction for a user of the client device to validate whether the insight output contains the insights.
